(19) United States
(12) Patent Application Publication
(10) Pub. No.: US 2007/0146209 A1
(43) Pub. Date: Jun. 28, 2007

(54) Condition detecting sensor

(75) Inventors: Hiroshi Touge, Ichinomiya-shi (JP); Takehiko Sugiura, Kariya-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi, Aichi (JP)

(21) Appl. No.: 10/594,428

(22) PCT Filed: Mar. 29, 2005
(86) PCT No.: PCT/JP05/05895

§ 371 Date: Sep. 26, 2006

(30) Foreign Application Priority Data
Mar. 30, 2004 (JP) 2004-100340

(51) Int. Cl. H01Q 1/24

(52) U.S. Cl. 343/702

(57) ABSTRACT

The invention provides a condition detecting sensor capable of measuring the distance between two members moving toward and away from each other without using changes in capacitance, as well as a condition detecting sensor capable of reliably sensing objects located between these two members regardless of their permittivity. The sensor comprises a first antenna FANT and a second antenna MANT arranged, respectively, on each of the two members moving toward and away from each other, a generator SOSC generating signal waves that can be transmitted by the first antenna FANT, and a mixer MIX connected to the first and second antennas FANT, MANT and mixing signals, and senses the distance between the two members moving toward and away from each other, as well as the presence of objects between the two members, by sensing the standing wave ratio between the first and second antennas FANT, MANT using a band-pass filter BPF and an S-meter SM.

### TECHNICAL FIELD

The present invention relates to a condition detecting sensor that is attached to two members moving toward and away from each other and senses the operative state of the members, i.e. the distance between the two members and the presence of objects located between the two members.

### BACKGROUND ART

Capacitive proximity sensors that detect capacitance changing depending on the degree of proximity of an object being detected and sense the proximity of an object are well-known (for instance, see Patent document 1, FIG. 2).

Such capacitive proximity sensors comprise oscillating means, resonating means resonating with the harmonics of the oscillation frequency of the oscillating means, and detecting means detecting signal variation based on changes in capacitance between the sensing electrode and an object being detected. When the object being detected comes in proximity to the sensing electrode, resonance changes take place and output voltage is changed due to the capacitance generated between the object being detected and the sensing electrode. The proximity of the object is detected by monitoring the output voltage.

Patent document 1: JP 2001-55852A.

### DISCLOSURE OF INVENTION

### Problem to be Solved by the Invention

Permittivity varies depending on the size of the target to be sensed and on whether the sensing target is a human, an physical object, etc. Accordingly, due to differences in permittivity, the capacitive proximity sensor described in patent document 1 was not suited to distance sensing. In addition, the problem was that the differences in permittivity made it impossible to accurately recognize sensing targets.

The present invention was made with account taken of the above-described problems and it is an object of the invention to provide a condition detecting sensor capable of measuring the distance between two members moving toward and away from each other without using changes in capacitance, as well as a condition detecting sensor capable of reliably sensing objects located between the two members regardless of their permittivity.

### MEANS FOR SOLVING PROBLEM

The characteristic features of the condition detecting sensor of the present invention used to attain the above-mentioned objects is that the sensor comprises a first antenna arranged on one of the two members moving toward and away from each other, a second antenna arranged on the other member and paired with the first antenna, a generator generating signal waves, a mixer connected to the first antenna, second antenna, and the generator and mixing signals, and a band-pass filter connected to the output of the mixer and passing only prescribed frequency bands, and that the distance between the two members, as well as the presence of objects between the two members, is sensed by sensing the strength of signals outputted from the band-pass filter.

According to these characteristic features, an antenna pair is formed by the first antenna and the second antenna. In addition, the distance between the antennas varies when the two members move toward and away from each other. As a result of such distance variation, the ratio of forward waves sent to the antenna pair and reflected waves returning from the antennas changes with time. Capturing such temporal changes makes it possible to learn information concerning the distance between the two antennas.

As a result, it is possible to sense whether the members are in operation or not in operation and, if they are in operation, whether they move in the same direction or in opposite directions.

In addition, when the members are in operation and another object approaches or is positioned between the two members, the ratio of the forward waves to the reflected waves does not change with time and manifests itself as a discontinuously changing waveform. Detection of such a discontinuous waveform allows for sensing objects different from the operative state of the members.

It should be noted that the two members moving toward and away from each other are not necessarily both movable, such that one of them may be a fixed member and the other a movable member.

Here, the condition detecting sensor preferably comprises an S-meter measuring the strength of the signal outputted from the band-pass filter.

S-meters are connected to automatic volume adjustment circuits of communication receivers and widely used for measuring the strength of received signals. Therefore, it is easy to obtain accurate meters and the mass productivity of devices can be improved using such S-meters to measure signal strength.

In addition, it is preferable to provide S-meters for measuring VSWR values outputted by the band-pass filter.

The term VSWR (Voltage Standing Wave Ratio) value refers to the voltage standing wave ratio, wherein the standing wave ratio is expressed in terms of voltage. The standing wave ratio represents the ratio between the maximum and minimum of waves produced by interference between the voltage of a forward wave directed towards an antenna, and a the voltage of a reflected wave that returns without being emitted from the antenna.

As described above, the present invention takes advantage of the fact that the ratio of forward waves sent to an antenna pair and reflected waves returning from the antennas changes with time. Therefore, such temporal changes can be captured quantitatively if the S-meter measures the VSWR value. As a result, this makes it possible to learn information concerning the distance between the two antennas.

In addition, to perform object sensing it is preferable to take the second derivative of the VSWR value.

Taking the second derivative of the VSWR value makes it possible to identify the points of inflection of the output waveform. This permits detection of VSWR value changes that are different from regular changes and enables sensing of objects different from the operative state of the members.

In addition, it is preferable to provide a downconverted signal generator connected to the mixer and generating a downconverted signal wave and allow the band-pass filter to detect only the difference between the signal wave and the downconverted signal wave.

Obtaining the difference between the signal wave and the downconverted signal wave allows for reducing the frequency. Effects obtained as a result of this include the fact that circuitry required for signal processing can be simplified and that general-purpose meters can be employed in circuits used for signal strength measurement.

As explained above, the present invention makes it possible to accurately sense the distance between two members moving towards and away from each other as well as the presence of objects between these two members regardless of their permittivity.

### BEST MODE FOR CARRYING OUT THE INVENTION

Some embodiments of the present invention are explained below by referring to drawings.

### Working Example 1

FIG. 1 illustrates the application of the present invention to a sliding door of a vehicle. The sliding door-equipped vehicle has a sliding door SD installed therein, which is a movable member capable of sliding over an opening, and a center pillar CP (pillar B), which is a fixed member. In addition, a variable space VA is formed when the sliding door SD is opened. Due to its construction, the sliding door SD opens and closes substantially in parallel to the center pillar CP.

A movable antenna MANT is installed at the peripheral edge of the sliding door SD illustrated in FIG. 1 (at the left edge of the sliding door SD in FIG. 1). A fixed antenna FANT is installed on the center pillar CP side of the vehicle body facing the movable antenna MANT. The movable antenna MANT and fixed antenna FANT are electrically connected to each other and function as an antenna ANT.

It should be noted that the movable antenna MANT and fixed antennal FANT correspond, respectively, to the first antenna or second antenna of the present invention and form an antenna pair. In addition, despite the fact that explanations in the present example have been based on the assumption that one of the two members moving toward or away from each other is a movable member, and the other member is a fixed member, the invention is by no means limited to such an arrangement. It would be the same even if both members were movable members.

A signal wave generator (SOSC) (corresponding to the “generator” of the present invention), which outputs a signal wave to the two antennas, is connected to the movable antenna MANT and fixed antenna FANT through a mixer MIX. Namely, the mixer MIX is electrically connected in such a manner that signals with a frequency of f1 emitted from the signal wave generator SOSC are supplied to the antenna ANT (both antennas FANT and MANT), and signals from the antenna ANT (both antennas FANT and MANT) are inputted to the mixer MIX. A downconverted signal generator DOSC used for downconverting reflected wave signals from the antenna ANT is connected to the mixer MIX. The frequency of the signals of the downconverted signal generator DOSC is designated as f2. Furthermore, a band-pass filter BPF, which transmits signals only from predetermined frequency bands, is connected to the output side of the mixer MIX. An S-meter (a signal strength meter, or a meter for measuring scattering parameters (scattering parameter)) SM, which is used for the determination of the voltage values of signals inputted from the band-pass filter BPF, is connected to the output side of the band-pass filter BPF. An S-meter SM is a meter measuring the signal strength (voltage value) of electric waves. Signals having the frequency components n×f2−m×f1 (where n and m are integers of 1 or more), and frequencies f1 and f2 are outputted from the output of the mixer MIX. The band-pass filter BPF removes only some of them, for instance, only the f2−f1 frequency components.

In this working example, the signal wave generator SOSC is set up to generate a signal having e.g. an f1=100 MHz. On the other hand, the downconverted signal generator DOSC, which generates downconverted signals, is set up to use an f2=110.7 MHz and permits generation of downconverted signals with f2−f1=10.7 MHz. The band-pass filter BPF is set up to extract only the 10.7 MHz frequency band. The 10.7 MHz frequency band is used because it is generally easy to detect with the help of an inexpensive S-meter. Although the generator DOSC makes use of frequencies in the MHz band, the same action is commonly achieved using frequencies from other bands. Therefore, the use of frequency bands beyond the frequencies of the MHz band is possible, with the frequency band determined by considering the length of the antenna, pertinent regulations, etc. In particular, the 24 GHz frequency band is a band where the human body (human arms, etc.) is liable to function as an antenna, which makes signals susceptible to absorption between the fixed antenna FANT and movable antenna MANT. In addition, based on n×f2−m×f1, the highest amplitude is typically obtained when n=m=1. Therefore, when f1=24 GHz, f2=24.017 GHz, and the band-pass filter BPF is set up to extract only the 10.7 MH frequency band, the selected values are suitable for detection of human bodies passing through a door.

FIG. 2 is a graph illustrating the relationship between the distance between the fixed member and movable member in the opening and the VSWR value, i.e. the output value of the S-meter SM. The VSWR value is a voltage value designating a voltage standing wave ratio and representing the peak-to-dip ratio of a voltage amplitude distribution generated along a transmission line, where reflected waves are generated as a result of impedance mismatch. In addition, in the present invention, the VSWR value varies when the distance between the fixed antenna FANT and movable antenna MANT changes. In other words, FIG. 2 illustrates temporal changes in the output waveform of the S-meter SM due to the operation of the movable antenna MANT when the sliding door SD, i.e. the movable member, is opened and closed.

When there are variations in the distance between the two antennas, i.e. the fixed antenna FANT and movable antenna MANT, the ratio of forward waves sent to the antenna ANT and reflected waves returning from the antenna ANT changes with time. For this reason, capturing these changes as temporal changes in the VSWR value makes it possible to learn information concerning the distance between the two antennas. The VSWR values, i.e. periodic voltages changes in the output voltage of the S-meter SM, are determined by the frequency of the downconverted signal generator DOSC and the frequency of the signal wave generator SOSC used in the present invention.

The sensing of temporal changes in the VSWR value in the manner described above makes it possible to sense whether the sliding door SD is in operation or not, and furthermore, if it is in operation, whether the movement is in the same direction or in the opposite direction. In addition, when the sliding door SD is in operation, the approach or presence of other objects results in a discontinuously changing waveform that differs from regular changes. Detection of the discontinuous waveform permits sensing of objects different from the operative state of the sliding door SD.

In terms of recognition of objects different from the sliding operation of the sliding door SD, accurate sensing is made possible by taking the second derivative of the VSWR value outputted from the S-meter SM. Differentiation of the output value in the manner described above permits identification of the points of inflection of the output waveform. This makes it possible to recognize whether there is something different from regular VSWR value changes that accompany the operation of the sliding door SD or, in other words, whether there is an object between the sliding door SD and the vehicle body.

As shown in FIG. 3, such an assessment can be performed with the help of an electronic control unit ECU, which accepts the output of the S-meter as input. The electronic control unit ECU can be implemented both using hardware and based on computers and computer software. The electronic control unit ECU operates according to the flow chart of FIG. 4.

In FIG. 4, the electronic control unit ECU accepts VSWR values outputted by the S-meter SM as input (Step #101). Next, the operation of the sliding door SD is qualified based on temporal changes in the VSWR values (Step #102). Here, actual VSWR value changes are compared with VSWR value changes typically produced when the sliding door SD is closed or opened. If the actual VSWR value changes are identical to the VSWR value changes typically produced when the sliding door SD is opened or closed, it can be determined that the sliding door SD is being opened or closed. If there are no changes in the VSWR values, it can be determined that the sliding door SD is at rest.

Next, the second derivative of the VSWR value is taken (step #103). The result obtained by taking the second derivative is compared with a predetermined value (Step #104) and, if the result is less than the predetermined value, an assessment is made (Step #105) to the effect that there is no foreign object intrusion, and, if the result is equal to or greater than the predetermined value, an assessment is made (Step #106) to the effect that there is foreign object intrusion. Step #101 and all the subsequent steps are then repeated.

In this manner, in an opening formed by a fixed member and a movable member, such as a vehicle door, etc., the condition detecting sensor of the present invention can be used as a sensor for sensing the distance between the fixed member and movable member or objects located between the fixed member and movable member.

### Working Example 2

FIG. 5 illustrates another working example of the sliding door SD employing the present invention. In Working Example 2, a fixed antenna FANT, which is installed on the fixed member, is formed into a loop that follows the shape of the opening. Additionally, a movable antenna MANT is installed at the left edge of the sliding door SD. Thus, the same functionality is obtained even though the fixed antenna FANT is installed such that it follows the shape of the opening in the door section.

FIG. 6 is a side-view of the sliding door illustrating the movable antenna MANT attached thereto, with the sliding door SD viewed along the B-B line of FIG. 5, i.e. in the anterior-to-posterior direction relative to the direction of movement of the vehicle. The sliding door SD is formed by welding an outer panel OPNL and an inner panel IPNL together, with the movable antenna MANT installed along the edge, from the top to the bottom of the door, and secured with screws in brackets BKT. The movable antenna MANT is coated with EPDM or another material to integrate it with the door, and, if the occasion demands, has a built-in touch sensor TS for sensing contact with objects. The material used for the coating is chosen with account taken of moisture proofness and insulating properties and can be appropriately selected from materials used for coating aerial cables, as well as from NBR-, urethane-, nylon-, and olefin-based materials or elastomeric materials, such as ethylene propylene rubber. The choice of material is based on the premise that it is guaranteed between −30° C. and 85° C., i.e. in the service temperature range.

FIG. 7 shows the movable antenna MANT in its attached state, as viewed in the A-A cross-section of FIG. 6. The movable antenna MANT is covered in cladding CLD and also secured to a bracket BKT. The bracket BKT is secured on top of the inner panel IPNL. The bracket BKT is constituted by an electrically conductive metal member and provides ground potential by being electrically connected to the vehicle body.

FIG. 8, which is a C-C cross-section taken in FIG. 5, shows the fixed antenna FANT in its attached state, installed in the vicinity of the center pillar CP. To seal gaps and prevent rain drops from getting inside the vehicle when the door is opened, a weather strip WS is attached to inner trimming ITRIM welded to the vehicle body. The weather strip WS, which is nearly O-shaped, consists of an elastomeric material and has a hollow configuration. In addition, the weather strip WS is secured to the inner trimming panel ITRIM using, for example, screws, via gaskets BWS. Because the gasket BWS is electrically conductive and is adapted to be electrically connected to the vehicle body, electrically, it provides a ground potential. Also, as shown in FIG. 8 (a) or FIG. 8(b), the fixed antenna FANT is adapted to be united with the weather strip WS.

In Working Example 2 described above, the construction of the antenna is different from Working Example 1, but other constituent elements, such as the mixer MIX, signal wave generator SOSC, downconverted signal generator DOSC, band-pass filter BPF, S-meter SM, electronic control unit ECU, etc. are the same as in Working Example 1.

### Working Example 3

FIG. 9 is an outline view of an antenna ANT installed in the opening of a sunroof. In this working example, a fixed antenna FANT and movable antenna MANT are not directly connected to each other. Arranging the two antennas so as to create substantial electrostatic coupling therebetween allows for configurations, in which the facing antennas operate as if they were electrically connected. Because the use of the above configurations makes it possible to abolish electrical connectors, the reliability of the circuit can be improved.

In addition, the accuracy of sensing is improved if ground lines FGND and MGND are arranged substantially in parallel to the two antennas such that they are insulated from the antennas FANT and MANT in the high-frequency range and grounded to the vehicle body.

In Working Example 3 described above, the construction of the antenna is different from Working Example 1, but other constituent elements, such as the mixer MIX, signal wave generator SOSC, downconverted signal generator DOSC, band-pass filter BPF, S-meter SM, electronic control unit ECU, etc. are the same as in Working Example 1.

### Working Example 4

FIG. 10 illustrates a working example, in which the present invention is applied to a vehicle window. The movable antenna MANT is arranged on glass, i.e. an insulator, and, in the same manner as in the working example of FIG. 9, there is no need for a direct wire connection between the movable antenna MANT and fixed antenna FANT, which may be electrostatically coupled.

In this configuration, as shown in FIG. 11, unlike the circuits of FIG. 1 and FIG. 9, the circuit used for detecting signals inputted from the antenna ANT uses a directional coupler 10, and signal processing may be performed using the mixer MIX to mix in signals from a reference oscillator 11 generating a reference frequency different from the signal wave generator

In addition, the accuracy of sensing is improved and recognition of fingers, etc. is facilitated by employing both sensors based on the antenna ANT described above and capacitive sensors.

### INDUSTRIAL APPLICABILITY

The present invention can be applied to object detecting sensors used for detecting the open/closed state of equipment that can be opened and closed and to open/closed state monitoring devices and jamming detection devices, etc. that employ such sensors. The opening/closing equipment includes, for instance, automobile power windows, power sliding doors, back doors, automatic doors and rotating doors in buildings and on railways, etc.

### BRIEF DESCRIPTION OF DRAWINGS

FIG. 1 is a general schematic view illustrating an embodiment of the present invention.

FIG. 2 is a schematic view illustrating the relationship between the VSWR and the distance of opening in the opening portion of the sliding door.

FIG. 3 is a block diagram illustrating an exemplary configuration, in which the presence of objects is assessed based on the waveform output of FIG. 2.

FIG. 4 is a flowchart explaining the operation of the electronic control unit of FIG. 3.

FIG. 5 is a schematic view of another embodiment, in which the present invention is applied to a sliding door of an automobile.

FIG. 6 is a schematic view of the sliding door in the B-B cross-section of FIG. 5.

FIG. 7 is a cross-sectional view illustrating antenna wiring in the A-A cross-section of FIG. 6.

FIG. 8 is a cross-sectional view illustrating antenna wiring in the C-C cross-section of FIG. 5.

FIG. 9 is a schematic view illustrating another embodiment of the present invention.

FIG. 10 is a schematic view illustrating another embodiment of the present invention.

FIG. 11 is a processing circuit illustrating another embodiment of the present invention.

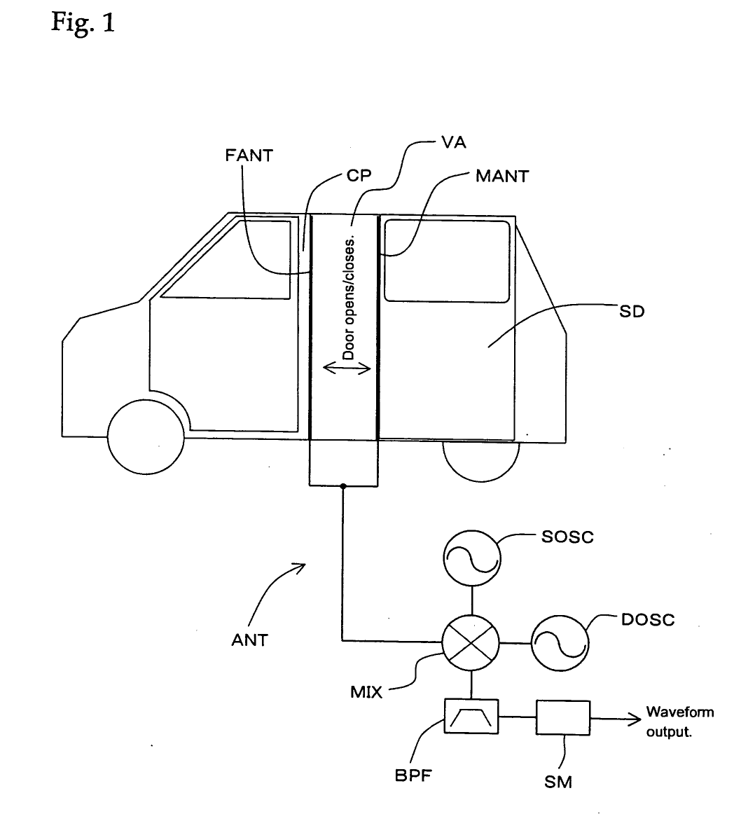

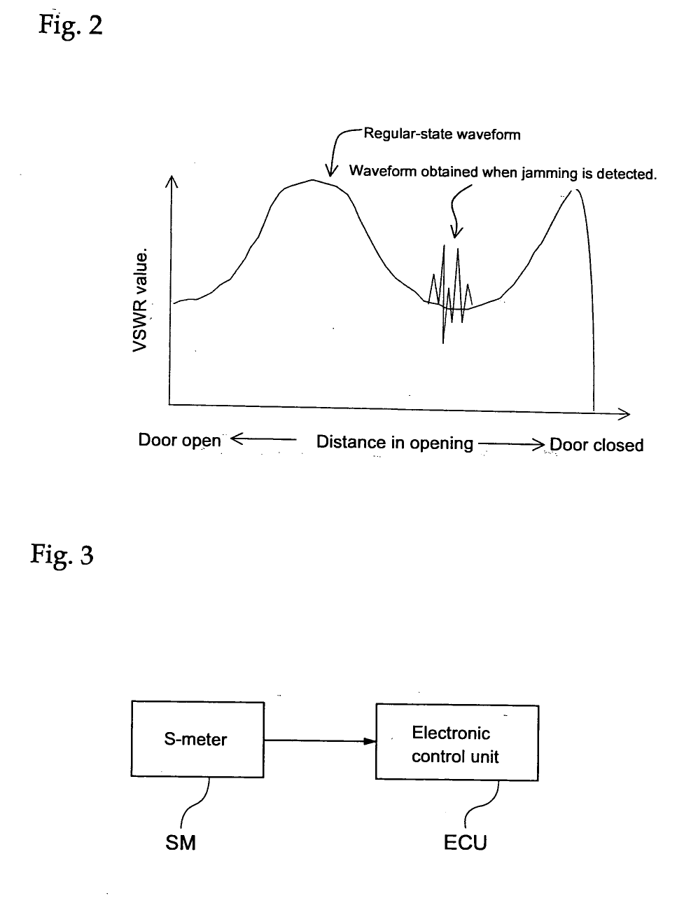

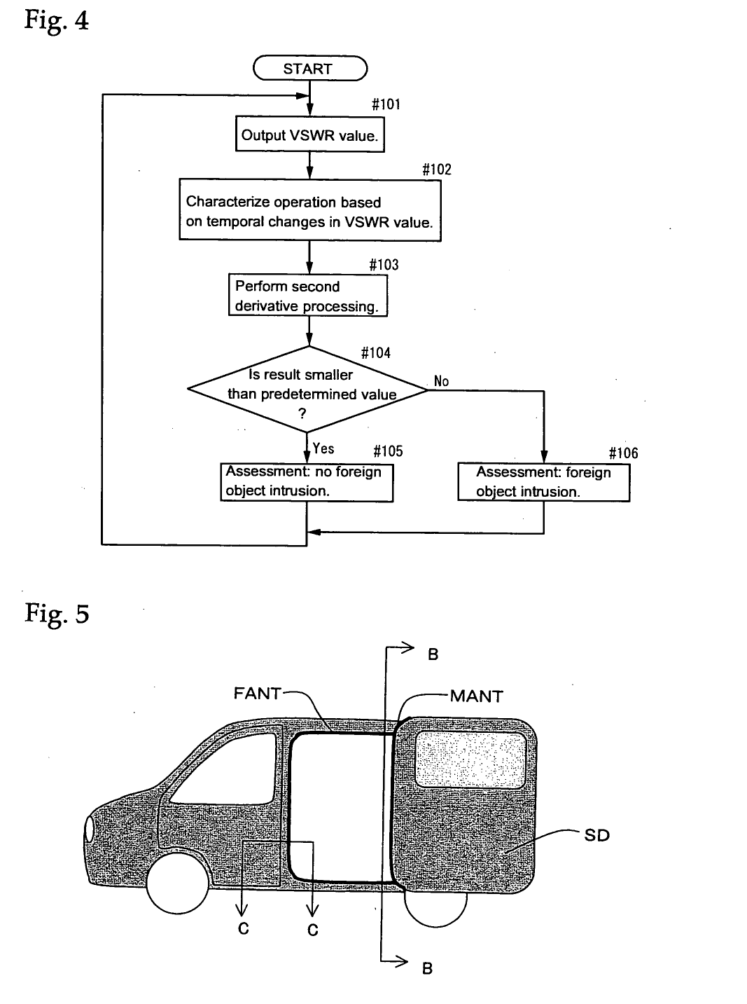

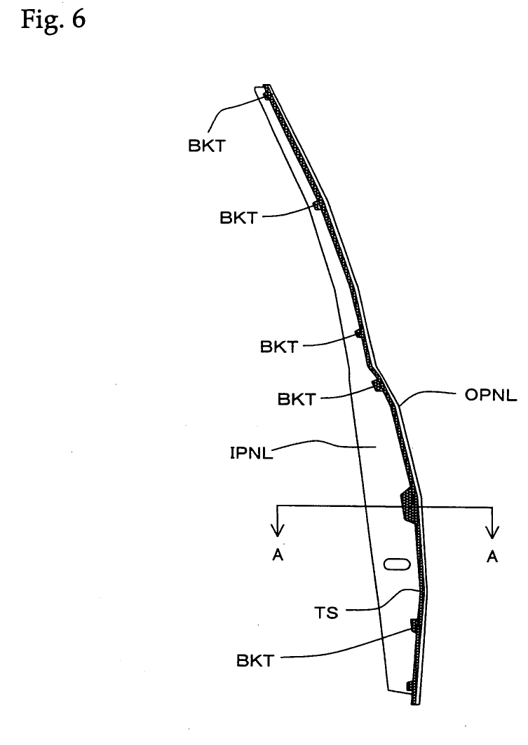

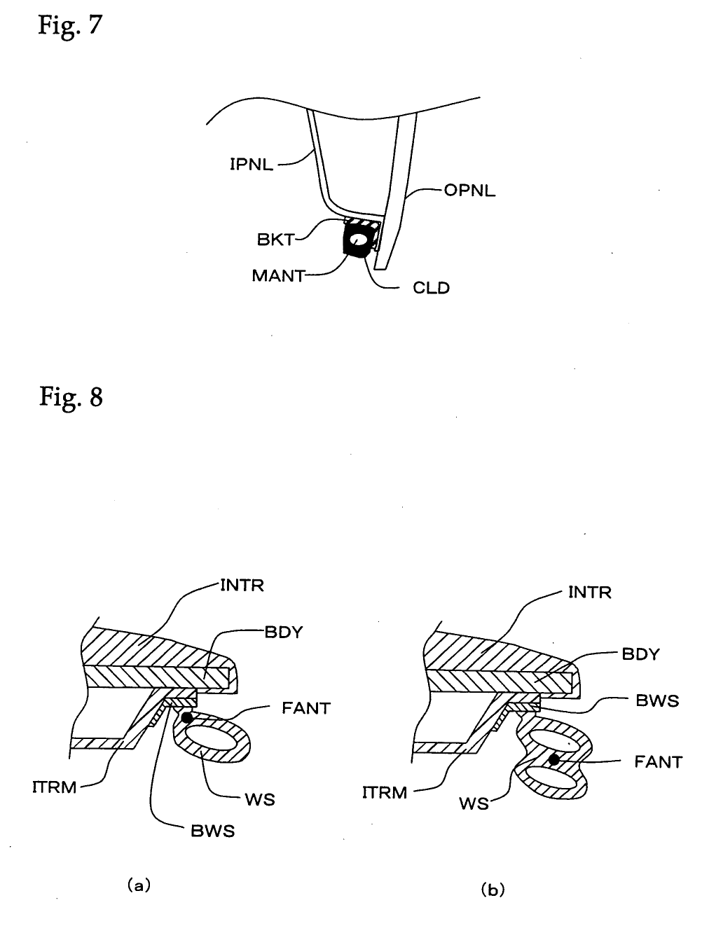

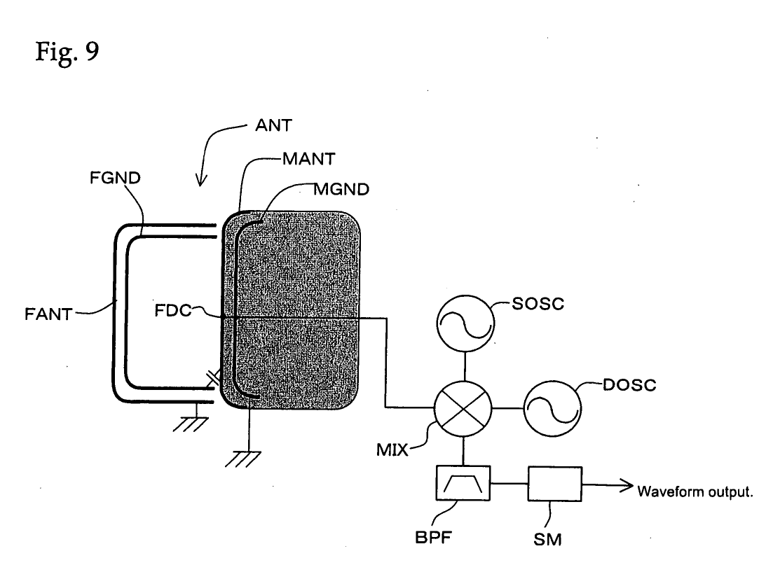

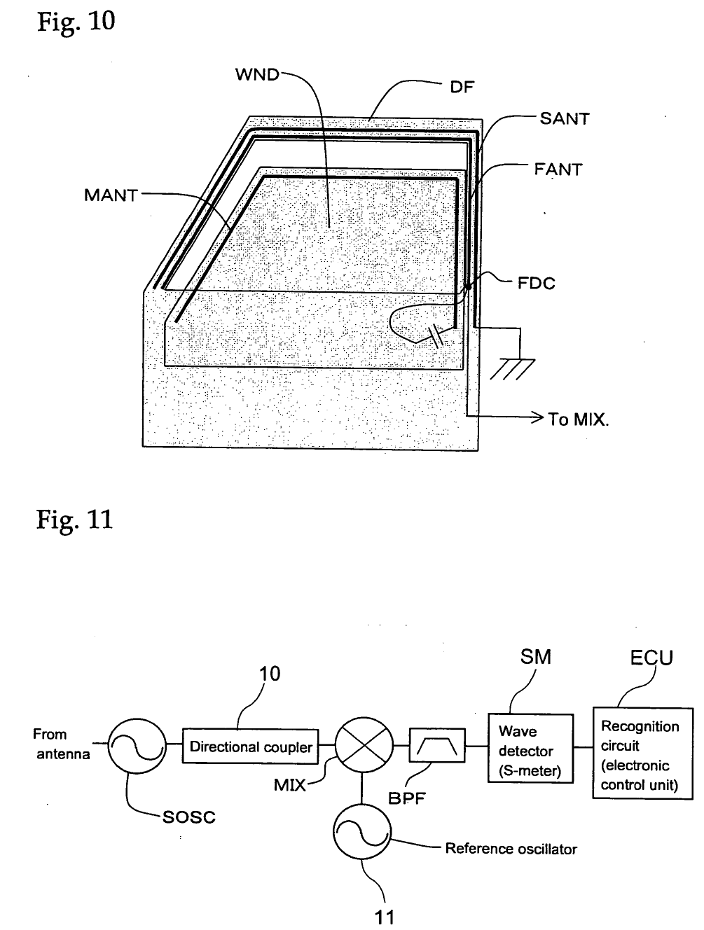

### DESCRIPTION OF REFERENCE NUMERALS

ANT antenna
BKT bracket
BPF band-pass filter
CP center pillar
DF door frame
FANT fixed antenna
FDC feed point
IPNL inner panel
MANT movable antenna
MIX mixer
OPNL outer panel
SD sliding door
SM S-meter
SOSC signal wave generator
TS touch sensor
VA variable space
WND window

1. A condition detecting sensor, comprising:
a first antenna arranged on one of the two members moving toward and away from each other,
a second antenna arranged on the other member and paired with the first antenna,
a generator generating signal waves,
a mixer connected to the first antenna, the second antenna, and the generator and mixing signals, and
a band-pass filter connected to an output of the mixer and passing only prescribed frequency bands,
wherein the condition detecting sensor senses a distance between the two members, as well as the presence of objects between the two members, by sensing the strength of the signal outputted from the band-pass filter.

2. The condition detecting sensor according to claim 1, comprising an S-meter measuring the strength of signals outputted from the band-pass filter.

3. The condition detecting sensor according to claim 1, comprising an S-meter measuring VSWR values in the output of the band-pass filter.

4. The condition detecting sensor according to claim 3 performing the sensing of objects by taking the second derivative of the VSWR value.

5. The condition-detecting sensor according to claim 1, comprising a downconverted signal generator generating a downconverted signal wave,
wherein the band-pass filter detects only a difference between the signal wave and the downconverted signal wave.
